(19) United States
(12) Patent Application Publication
(10) Pub. No.: US 2004/0013101 A1
(43) Pub. Date: Jan. 22, 2004

(54) Method and system for allocating power and scheduling packets in one or more cells of a wireless communication system or network

(76) Inventors: Huseyin C. Akin, New York, NY (US); Ozdemir Akin, Raleigh, NC (US)

Correspondence Address: BROOKS KUSHMAN P.C., 1000 TOWN CENTER, TWENTY-SECOND FLOOR, SOUTHFIELD, MI, 48075, US

(21) Appl. No.: 10/442,696

(22) Filed: May 21, 2003

Related U.S. Application Data
(60) Provisional application No. 60/382,819, filed on May 23, 2002.

(51) Int. Cl. H04B 7/216

(52) U.S. Cl. 370/342; 370/395.21

(57) ABSTRACT

Methods and systems are provided for allocating transmitting power and scheduling packets in one or more cells of a wireless communication system or network. The wireless communication system has a plurality of wireless cells. Each of the wireless cells includes a base station and a plurality of wireless stations. The method includes determining a channel gain for each preselected wireless station in the first wireless cell. Intercell interference experienced within the first wireless cell caused by the other wireless cells is determined. A power allocation and scheduling scheme is determined, based on the determined channel gains and the determined intercell interference. Transmitting power values and corresponding transmitting time durations within the first wireless cell are assigned, based on the scheme to improve total throughput in the first wireless cell.

### CROSS-REFERENCE TO RELATED APPLICATION

This application claims the benifit of U.S. provisional application Serial No. 60/382,819, filed May 23, 2002 and entitled “Modulation Optimized Spectrum Technology (M.O.S.T.).”

### BACKGROUND OF THE INVENTION

1. Field of the Invention

This invention relates to methods and systems for allocating power, and scheduling packets in one or more cells of a wireless communication system or network. This invention has particular utility in multimedia CDMA systems but also has utility in other systems such as voice connections, a combination of multi-media and voice, etc.

2. Background Art

The innovations and markets in wireless communications have been motivating factors for each other for a couple of decades now and are believed to continue to be so in the future. Many different wireless access mediums have been suggested and deployed over time including analog systems, AMPS, GSM, TDMA and CDMA based designs for the first and second generation wireless cellular and PCS (Personal Communication Systems). The variety of services that should be supported by the next generation wireless systems include different service types such as voice, real-time video and other data types with various QoS (Quality of Service) requirements. CDMA is emerging as the leading standard for the third generation wireless personal communication systems with the hope of satisfying all those needs.

The need for a common wireless standard of the existing second generation systems as well as the need for further development of these systems to support multimedia services, has resulted in the IMT-2000 initiative under the International Telecommunication Union (ITU).

Various bodies developed proposals, namely European Telecommunications Standards Institute (ETSI) in Europe, Telecommunications Industry Associations (TIA) in United States, Association of Radio Industries and Businesses (ARIB) in Japan, and Telecommunications Technology Association (TTA) in South Korea. After the submissions, in December 1998 ARIB, ETSI, Committee T1 (United States) and TTA initiated the 3rd Generation Partnership Project (3GPP) in order to further improve the standardization efforts.

By the end of the first quarter of 1999, the decision was finalized by announcing wideband CDMA (W-CDMA) as the winning standard. The W-CDMA standard has three optional modes: direct sequence (DS); frequency-division duplex (FDD) based on ETSI's and ARIB's FDD proposal; multicarrier (MC) FDD based on TIA's CDMA-2000 proposal; and DS time division duplex (TDD) based on ETSI's proposal. Another committee named 3GPP2 is also working on CDMA-2000 standards. The last hurdle for the development of IMT-2000 was resolved by the end of March 1999.

The earliest field trials of 3G systems by NTT Docomo (Japan) and Vodafone (United Kingdom) were originally scheduled for the second quarter of 2001 but were delayed until very recently. NTT DoCoMo in Japan has rolled out the first 3G services in limited markets and has struggled with technical glitches.

Unlike TDMA-based systems, in CDMA systems the terminals transmit continuously and simultaneously on the same frequency band. The information sent through the channel is not separated by time, but by the spreading codes. Each connection is assigned a single spreading code and that spreading code is orthogonal to every other spreading code of other users. Depending on the availability, the spreading codes can be pseudo-orthogonal instead of perfectly orthogonal. Each user's connection is spread over the whole spectrum via this spreading, therefore the name spread-spectrum.

FDD-CDMA

This standard can be viewed as the extension of the Interim Standard 95 (IS-95). This standard was initially developed by Qualcomm and later was adopted by TIA in 1993. Because of the need for larger data rates, an extended bandwidth per carrier is used (5 Mhz). The uplink channel is the 1920-1980 Mhz band totaling 12 carriers. The downlink channel is in the 2110-2170 Mhz band.

The spreading factor (data bit duration over chip duration) varies between 4-256, and the supported bit rates range between 8 kb/s-2 Mb/s. QPSK modulation is used in both directions. Convolutional coding with rates ⅓ or ½ and Turbo codes with rates ⅓ or ½ are optional coding schemes.

TDD-CDMA

In this system the 5 Mhz bandwidth is shared by both the uplink and downlink directions during different time slots. The modulation is QPSK in both uplink and downlink. The forward error correction schemes are the same as in the FDD scheme. The characteristics (logical channels, frame format, etc.) of UMTS-TDD are similar to those of GSM. Generally, both FDD and TDD standards intend to coexist with GSM and allow the users to seamlessly hand over between all three systems.

MC-CDMA

MC-CDMA is a form of CDMA where the spreading is applied in the frequency domain instead of in the time domain, as in DS-CDMA. Each user's signal is transmitted over a large number of orthogonal carriers (orthogonal frequency division multiplexing—OFDM) exploiting spectral diversity. Although one of the UMTS standard, OFDM has gained momentum in wireless local area networks (WLANs). Because of the poor performance of a pure OFDM system usually coded-OFDM (C-OFDM) systems are used. The carrier-interferometry CDMA (CI-CDMA) is a recent promising example of a multi carrier CDMA design.

Because of the error-prone nature and the limited resources of bandwidth of the wireless communications mediums, bandwidth efficiency is very important. In CDMA systems all the wireless stations transmit simultaneously to the base station that they are assigned to in the uplink (reverse link). In a single cell every wireless user introduces noise in the form of interference to every other wireless station's uplink communications within the cell. The higher a wireless station's transmitting power, the better throughput that user gets for its connection, but the higher interference it causes for the other wireless stations at the same time. Therefore, there is a dynamic trade-off between each individual user's throughput and the total throughput of the system. Additionally, the received power of a wireless station closer to the base station is higher than the received power of a wireless station which is not as close, if they have similar channel gains and similar transmitting powers. This would cause unfairness issues unless some kind of power normalization is done. Traditionally, “perfect power control” is employed to cope with this near-far phenomena. This is simply done by allocating the transmitting powers of each wireless station in that cell such that the received powers of those wireless users at the base station would be equal. This is achieved by employing closed loop power control in the uplink. In today's CDMA designs the base station sends a one-bit power control command over the dedicated physical control channel (DPCCH) on the downlink to order the wireless station to power up if the signal to noise ration (SNR) value of the wireless station, measured at the base station is less than the target value or to power down if the SNR is above the target value. The target SNR values are set to accommodate as many wireless stations as possible with the least acceptable performance measures, i.e. bit error rates (BER). If the target value of a particular individual wireless user is set too high, he will get a high SNR (high performance) but will cause a lot of interference to other wireless stations. This will tremendously degrade the total capacity of the system. On the other hand if the target SNR for a particular wireless station is set too low, the wireless user will experience unacceptable low performance. This has been the common approach and implicit assumption in the literature.

Power control and its analysis for uplink and downlink has attracted attention.

The limited capacity of wireless telecommunication media, with the expectation of upcoming multimedia applications with different QoS has attracted attention to resource allocation issues in wireless systems as well. Some of the approaches are described in the following:

S. -J. Oh, K. M. Wasserman “Dynamic Spreading Gain Control in Multiservice CDMA Networks” IEEE Journal on Selected Areas in Communications, vol. 17, no. 5, pp. 918-927, May 1999.

S. -J. Oh, K. M. Wasserman “Optimal Resource Allocation in Wideband CDMA Networks” vol._, no._, pp._{—}, 1999.

L. Ortigoza-Guerrero, A. H. Aghvami “A Distributed Dynamic Resource Allocation for a Hybrid TDMA/CDMA System” IEEE Transactions on Vehicular Technology, vol. 47, no. 4, pp. 1162-1178, November 1998.

K. S. Park, D. H. Cho “An Advanced Channel Access Scheme for Integrated Multimedia Services with Various Bit Rates in CDMA Networks” IEEE Communications Letters, vol. 3, no. 4, pp. 91-93, April 1999.

L. Tan, Q. T. Zhang “A Reservation Random-Access Protocol for Voice/Data Integrated Spread-Spectrum Multiple-Access System” IEEE Journal on Selected Areas in Communications, vol. 14, no. 9, pp. 1717-1727, December 1996.

S. Lal, E. S. Sousa “Distributed Resource Allocation for DS-CDMA-Based Multimedia ad hoc Wireless LAN's” IEEE Journal on Selected Areas in Communications, vol. 17, no. 5, pp. 947-967, May 1999.

S. Kumar, S. Nanda “High Data-Rate Packet Communications for Cellular Networks Using CDMA; Algorithms and Performance” IEEE Journal on Selected Areas in Communications, vol. 17, no. 3, pp. 472-492, March 1999.

A. Jalali, R. Padovani, R. Pankaj “Data Throughput of CDMA-HDR a High Efficiency-High Data Rate Personal Communication Wireless System” IEEE Vehicular Technology Conference, vol._, no._, pp._{—}, 2000.

L. C. Yun, D. G. Messerschmitt “Power Control for Variable QoS on a CDMA Channel” IEEE, vol._, no._, pp. 178-182, 1994.

O. Gurbuz, H. Owen “Dynamic Resource Scheduling Schemes for W-CDMA Systems” IEEE Communications Magazine, vol._, no._, pp. 80-84, October 2000.

S. Ramakrishna, J. M. Holtzman “A Scheme for Throughput Maximization in a Dual-Class CDMA System” IEEE Journal on Selected Areas in Communications, vol. 16, no. 6, pp. 830-844, August 1998.

S. Choi, K. G. Shin, “An Uplink CDMA System Architecture with Diverse QoS Guarantees for Heterogeneous Traffic” IEEE/ACM Transactions on Networking, vol. 7, no. 5, pp. 616-628, October 1999.

A. Sampath, P. S. Kumar, J. M. Holtzman “Power Control and Resource Management for a Multimedia CDMA Wireless System” IEEE, vol._, no._, pp. 21-25, 1995.

J. B. Kim, M. L. Honig “Resource Allocation for Multiple Classes of DS-CDMA Traffic” IEEE Transactions on Vehicular Technology, vol. 49, no. 2, pp. 506-519, March 2000.

M. Airy, K. Rohani “QoS and Fairness for CDMA Packet Data” IEEE Vehicular Technology Conference, vol._,no._, pp. 450-454, 2000.

With today's traditional CDMA systems and with no sectorization, one cell can only accommodate less than a handful of wireless connections at a time with 150K bits/sec rates. Although 1-2M bits/sec rates are advertised for 3G CDMA networks, those rates are theoretical upper bounds for a single connection per cell. This highlights how important the capacity is going to be for wireless personal communication systems, especially with the introduction of high rate services like video-phone, realtime audio and video as well as many other future applications.

CDMA systems constitute a communication system where the multiple access nature is achieved by means of coding. Each transmitter is assigned a unique code and the information-bearing signal is encoded by this code. Receiver, knowing the exact code of the transmitter, decodes the received signal to recover the original information-bearing signal. Since the bandwidth of the code is larger than the original signal, encoding spreads the spectrum of the signal.

The CDMA techniques were originally developed for military purposes, because of the resistance against jamming and low probability of interception properties of CDMA systems. With the increasing demand and need in the commercial telecommunications, CDMA was adopted for commercial use.

The encoding of the information signal with a code signal that is independent of the data results in a spreaded signal which has a much larger spectral width than the data signal. This spreads the original signal power over a much broader bandwidth, resulting in a lower power density. The ratio of transmitted bandwidth to information bandwidths is called the processing gain (also referred to as the spreading factor in the previous section) of the spread spectrum system.

If multiple users transmit spread spectrum signals at the same time, the receiver, knowing the exact code of the signal it wants to decode, will be able to recover the original signal if it has sufficiently low cross-correlation with the other coded signals. Correlating the received signal with a code signal from a certain user will then only despread the signal of this user, while the other spread-spectrum signals will remain spread over the large bandwidth. Thus, the power of the encoded signal in the despread narrow spectrum will be much higher than the other users' spread power interference in this narrow bandwidth, provided that the number of interfering users are not too high. Therefore, the original signal can be extracted.

In a radio communication channel there is usually more than one path. The signal is transmitted over various paths. Signals from different paths are the same signal only with different amplitudes and phases. Therefore, adding these signals might be constructive at some frequencies and destructive at others. This will result in a dispersed signal in the time domain. This phenomena is called the multi-path interference. Spread spectrum modulation can combat multipath fading; however, the way in which this is done depends on the type of modulation used.

In a CDMA protocol the modulated data signal is directly modulated by a digital code signal. In the case of a digital data signal, the data modulation is omitted and the data signal is directly multiplied by the code signal and the resulting signal modulates the wideband carrier. This type of CDMA modulation is therefore named as direct-sequence CDMA (DS-CDMA, hereinafter merely “CDMA”). FIG. 1 is a simplified DS-CDMA transmitter block diagram.

In FIG. 2, there is illustrated an output of a CDMA transmitter. The processing gain value is 10 in FIG. 2. In practice, values may be in the order of up to 10³.

After the signal is transmitted through the wireless channel, the receiver uses coherent demodulation to despread the spread spectrum signal, using locally generated code sequence. To be able to perform the demodulation operation, the receiver must not only generate the code sequence used to spread the sequence, but the codes of the received signal and the locally generated code must also be synchronized. This synchronization must be accomplished at the beginning of the reception and maintained until the whole signal has been received. The synchronization/tracking issue is important and is usually a design objective for a regular CDMA system. After despreading a data modulating signal results and after demodulating this signal, the original data bits can be recovered. A simplified receiver diagram is shown in FIG. 3.

### SUMMARY OF THE INVENTION

An object of the present invention is to provide an improved method and system for allocating power and scheduling packets in one or more cells of a wireless communication system or network. The present invention can be applied to all or a selection of cells or cell sites to improve throughput of the system or network.

In carrying out the above object and other objects of the present invention, a method for allocating transmitting power and scheduling packets in a first wireless cell of a wireless communication system having a plurality of wireless cells to improve throughput in the first wireless cell is provided. Each of the wireless cells includes a base station and a plurality of wireless stations. The method includes: a) for each preselected wireless station of the first wireless cell, determining a channel gain; b) determining intercell interference experienced within the first wireless cell caused by the other wireless cells; c) determining a power allocation and scheduling scheme based on the determined channel gains and the determined intercell interference; and d) assigning transmitting power values and corresponding transmitting time durations within the first wireless cell based on the scheme to improve total throughput in the first wireless cell.

Each of the wireless stations may have quality of service requirements, and the step of determining the scheme may also be based on the quality of service requirements of the preselected wireless stations in the first wireless cell.

The method may further include determining background noise experienced within the first cell. The step of determining the scheme may also be based on the determined background noise.

The method may further include repeating steps a)-d) when at least one of the channel gains or the intercell interference changes by a predetermined amount to obtain a new power allocation and scheduling scheme. The step of assigning may be based on the new scheme.

The method may further include repeating step d) as long as the channel gains and the intercell interference do not change by a predetermined amount or until the topology of the connections changes (i.e., such as by a new user being activated, a connection being terminated, etc.).

The transmitting power values may be less than maximum power levels to limit intercell interference introduced to other wireless cells of the system.

The step of determining the scheme may include the step of calculating the scheme.

The step of determining the scheme may further include the step of selecting the scheme from a plurality of precalculated stored schemes.

Each of the determined channel gains may be an estimate.

The determined intercell interference may be an estimate.

The step of determining a channel gain for each preselected wireless station of the first wireless cell may be based on power received at the base station of the first wireless cell.

The step of determining intercell interference may include the step of determining intercell interference experienced by the base station of the first wireless cell.

The step of determining intercell interference may include the step of determining intercell interference experienced by the preselected wireless stations of the first wireless cell.

Further in carrying out the above object and other objects of the present invention, a system for allocating transmitting power and scheduling packets in a first wireless cell of a wireless communication system having a plurality of wireless cells to improve throughput in the first wireless cell is provided. Each of the wireless cells includes a base station and a plurality of wireless stations. The system includes means for determining a channel gain for each preselected wireless station of the first wireless cell, and means for determining intercell interference caused by the other wireless cells. The system further includes means for determining a power allocation and scheduling scheme based on the channel gains and the determined intercell interference. The system still further includes means for assigning transmitting power values and corresponding transmitting time durations within the first wireless cell based on the scheme to improve total throughput in the first wireless cell.

Each of the wireless stations may have quality of service requirements, and the means for determining the scheme determines the scheme also based on the quality of service requirements of the preselected wireless stations in the first wireless cell.

The system may further include means for determining background noise experienced in the first wireless cell. The means for determining the scheme determines the scheme also based on the determined background noise.

At least one of the channel gains or the intercell interference changes by a predetermined amount, and the means for determining the scheme determines a new power allocation and scheduling scheme based on the channel gains and the intercell interference. The means for assigning may assign transmitting power values and corresponding transmitting time durations based on the new scheme.

The means for assigning may assign the transmitting power values and corresponding transmitting time durations as long as each of the channel gains and the intercell interference do not change by a predetermined amount or until the topology of the connections changes (i.e., such as by a new user being activated, a connection being terminated, etc.).

The transmitting power levels may be less than maximum power levels to limit intercell interference introduced to other wireless cells of the system.

The means for determining the scheme may include means for calculating the scheme.

The means for determining the scheme may further include means for selecting the scheme from a plurality of precalculated stored schemes.

Each of the determined channel gains may be an estimate.

The intercell interference may be an estimate.

The means for determining a channel gain for each of the preselected wireless stations of the first wireless cell may determine channel gains based on power received at the base station of the first wireless cell.

The means for determining intercell interference may determine intercell interference experienced by the base station of the first wireless cell.

The means for determining intercell interference may determine intercell interference experienced by the preselected wireless stations of the first wireless cell.

Further in carrying out the above object and other objects of the present invention, a method is provided for allocating transmitting power and scheduling packets in one or more selected cell sites of a wireless network having a plurality of cell sites to improve total achievable throughput, and therefor capacity, of the entire network. Each of the cell sites includes a base station and a plurality of wireless stations. The method includes a) for each preselected wireless station of the one or more selected cell sites, determining a channel gain; b) determining intercell interference experienced within the one or more selected cell sites caused by the other cell sites of the network; c) determining one or more power allocation and scheduling schemes based on the determined channel gains and the one or more determined intercell interferences; and d) assigning transmitting power values and corresponding transmitting time durations within the one or more selected cell sites based on the one or more schemes, respectively, to improve total achievable throughput, and therefor capacity, of the entire network.

Still further in carrying out the above object and other objects of the present invention, a system is provided for allocating transmitting power and scheduling packets in one or more selected cell sites of a wireless network having a plurality of cell sites to improve total achievable throughput, and therefor capacity, of the entire network. Each of the cell sites includes a base station and a plurality of wireless stations. The system includes means for determining a channel gain for each preselected wireless station of the one or more selected cell sites. The system further includes means for determining intercell interference caused by other cell sites of the network. The system still further includes means for determining one or more power allocation and scheduling schemes based on the channel gains and the one or more determined intercell interferences. The system still further includes means for assigning transmitting power values and corresponding transmitting time durations within the one or more selected cell sites based on the one or more schemes, respectively, to improve total achievable throughput, and therefor capacity, of the entire network.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a block diagram view of a prior art CDMA transmitter;

FIG. 2 are prior art timing diagrams of a BPSK modulated spread-spectrum signal;

FIG. 3 is a block diagram view of a prior art CDMA receiver;

FIG. 4 is a 3-D graph which illustrates total throughput as a function of received powers; and

FIG. 5 is a block diagram flow chart of the power allocation method of the present invention.

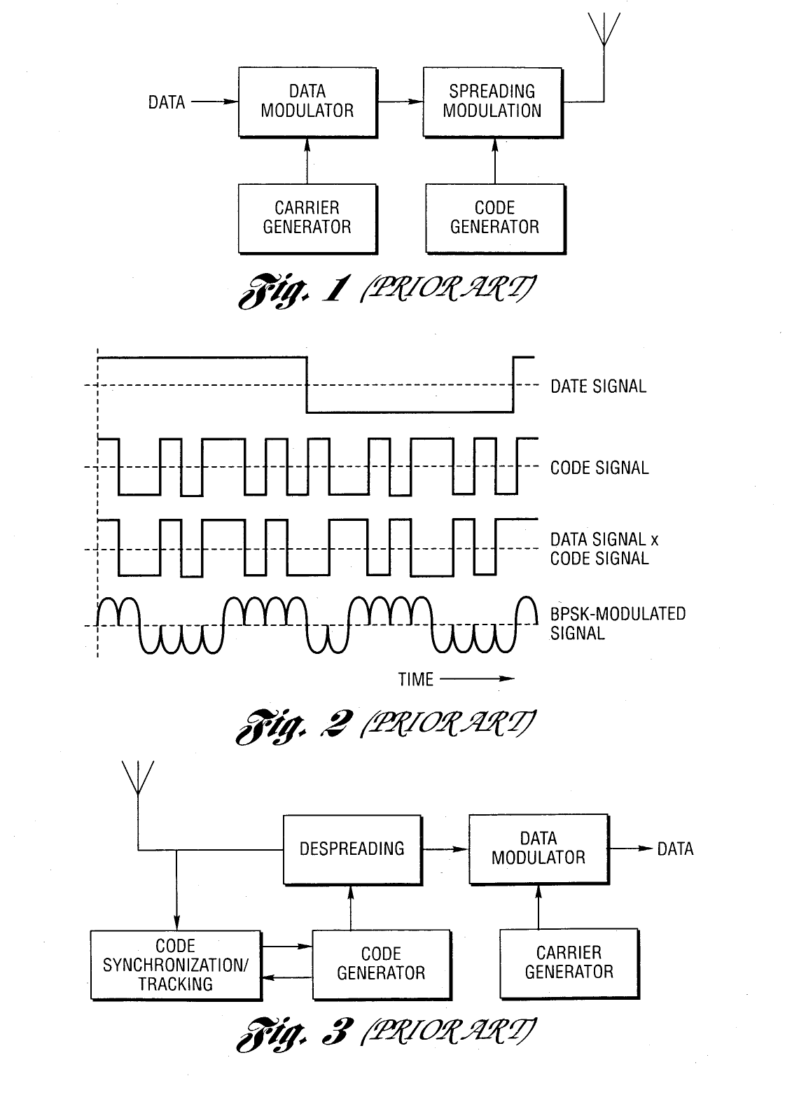

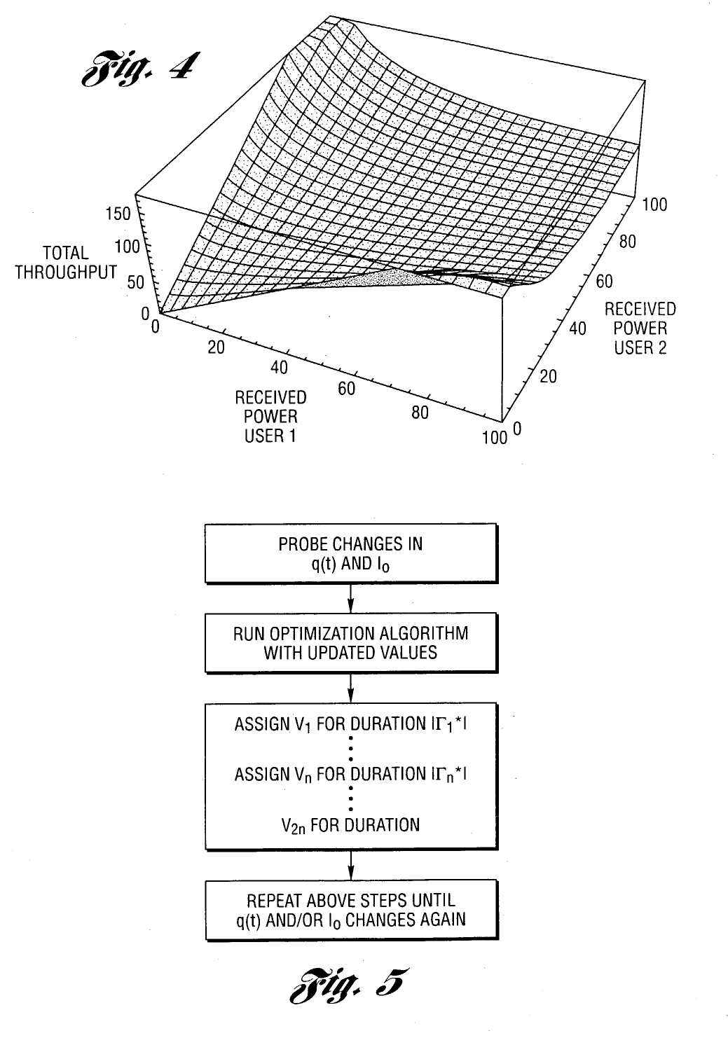

### DETAILED DESCRIPTION OF THE PREFERRED EMBODIMENT(S)

Assumptions, Notation and Analysis

The initial focus of this description is on the reverse link in a CDMA system. It is that every wireless station is assigned to a single base station and stays assigned to that base station throughout its connection. Every wireless station has some data to transmit with different QoS requirements during its connection lifetime. It is further assumed, without loss of generality, that every wireless station has a single connection and the QoS requirement of that connection is not changing with time. It is to be understood that these assumptions are for illustrative purposes only.

Let M be the number of wireless stations in a particular cell of interest with p(t)=(p₁(t), p₂(t), . . . , p_{M}(t)) denoting the transmitted power vector with time dependencies. Similarly define q(t)=(q₁(t), q₂(t), . . . , q_{M}(t) as the time dependent received power vector at the base station. Therefore q(t)=g(t)·p(t)^{T} where g(t)=(g₁(t), g₂(t)) is the channel gains vector of the wireless stations. In an ideal “perfect power controlled” CDMA system, ((q(t)))=q for some constant q∈R. In today's CDMA systems, the desired q value is set with the open-loop power control and the fluctuations from the value q is offset by the closed-loop power control. Usually the desired value for q is aimed at the background noise level.

In practical systems one has transmission power limitations. Define P=(P₁, P₂, . . . , P_{M}) as the maximum allowed transmission power vector. Also let I₀ denote the intercell interference (interference caused by the wireless stations from the neighbor cells) plus the background noise experienced by the base station. In general the value of I₀ will be time dependent, but for the time being for short time durations it is assumed that I₀ is constant.

There is a unique mapping from the BER requirement of an uplink connection to the required E_{b}/N₀ value at the base station, where E_{b} is the energy per bit and N₀ is the total noise experienced at the base station for that connection. This mapping depends on factors such as the modulation scheme, interleaving method and error-correction scheme. Therefore, one assumes the wireless stations define their QoS requirements in terms of their E_{b}/N₀ needs. Let κ=(K₁, K₂, . . . , K_{M}) be the QoS requirements vector.

At a snapshot of the system, the following equation holds:

$${( \frac{{E}_{b}}{{N}_{0}} )}_{i} = \frac{W}{{R}_{i}} \frac{{g}_{i} {p}_{i}}{{\sum }_{j \neq i} {g}_{j} {p}_{j} + {I}_{0}} , ∀ i ∈ \{ 1 , 2 , … , M \} \qquad ( 1 )$$

where Rᵢ is the throughput of the ith wireless station for a unit time duration (rate) and W is the bandwidth of the uplink. Notice that the righthand side of the equation is the processing grain multiplied by the user's received power divided by the total noise power that user is experiencing. (E_{b}/N₀)ᵢ and Rᵢ are inversely proportional, therefore the QoS requirements should be met with equality, (E_{b}/N₀)−κᵢ, for throughput maximization; since one can always lower the E_{b}/N₀, increase Rᵢ and keep every other value constant in equation (1) as long as the E_{b}/N₀ requirement is satisfied. Therefore, the throughput of the ith wireless station in the [0,t] time interval is given by:

$${h}_{1} ( 0 , t ) = {\int }_{0}^{t} {R}_{i} ( t ) ⅆ t = \frac{W}{{K}_{i}} {\int }_{0}^{t} \frac{{g}_{i} ( t ) {p}_{i} ( t )}{{\sum }_{j \neq } {g}_{j} ( t ) {p}_{j} ( t ) + {l}_{0}} ⅆ t \qquad ( 2 )$$

Before one continues with the throughput maximization problem, one could get some insight about the dynamics of the total throughput of a CDMA system. Notice that there is a close relation between the maximum achievable total throughput and the capacity of the system. For easy visualization, consider a two wireless station CDMA system in a cell site served by the same base station. The 3-D plot below has the total throughput of the cell (h₁(0,t)+h₂(0,t)) on the z axis and the received powers of wireless station 1 (q₁) and wireless station 2 (q₂) on the x and y axes, respectively.

The graph shows the achievable total throughput for any combination of the received powers at the base station. It is interesting to notice that although no point above the graph is achievable with a pure CDMA system; a time division combination of the vertices can achieve any point on the four planar triangles, each of which are defined by the 3 points selected among the 4 vertex points. This motivates for a search of an optimum time division combination of vertices which are pure CDMA's by themselves (search for an optimum linear combination of the 4 vertex points in our example).

Throughput Maximization Problem

Let ρ=(ρ₁, ρ₂, . . . , ρ_{M}) be the minimum required rates vector. Define the sets

$$Φ = \{ R \vert \frac{{\int }_{0}^{t} {R}_{i} ( t ) ⅆ t}{t} \geq {ρ}_{i} , ∀ i = 1 , 2 , … , M \}$$

and Ψ={p|0≦p≦P} as the required rate and feasible power vector sets, respectively. (Here the vector relations correspond to componentwise relations.) Assume that the connection topology stays the same during the [0,t] time duration (i.e. all established connection stay connected and no new connections are added during this time period) and further assume that [0,t] is short enough so that the channel gains are constant. If one denotes H(o,t)=Σᵢhᵢ(o,t) Σᵢhᵢ(0,t) as the total throughput then the total uplink throughput maximization problem of the cell is given by:

$${sup}_{R ∈ Φ , p ∈ Ψ} H ( 0 , t ) = {sup}_{R ∈ Φ , p ∈ Ψ} {\sum }_{i}^{} \frac{W}{{κ}_{i}} {\int }_{0}^{t} \frac{{g}_{i} {p}_{i} ( t )}{{\sum }_{j \neq i} {g}_{j} {p}_{j} ( t ) + {I}_{0}} ⅆ t \qquad ( 3 )$$

When one looks at the generic optimization problem defined by Equation (3), one can easily anticipate the difficulty in solving this maximization. Clearly, the set that defines the domain for optimization is infinite and there is no clear method of eliminating the best solution candidates other than trial and error which is infeasible.

To further manipulate this equation, the integration is changed with a summation over a partition Γ of the [0,t] time interval where the transmitted power levels are constant in each subinterval Γᵢ=(tᵢ,tᵢ₊₁), i=1,2, . . . , K, for a large enough K. This is a valid assumption for any practical system. Therefore the optimization problem becomes:

$${max}_{R ∈ Φ , p ∈ Ψ} H ( 0 , t ) = {max}_{R ∈ Φ , p ∈ Ψ} {\sum }_{i}^{} \frac{W}{{κ}_{i}} {\sum }_{n = 1}^{K } \frac{{g}_{i} {p}_{in} \vert {Γ}_{n} \vert}{{\sum }_{j \neq i} {g}_{j} {p}_{jn} + {I}_{0}} \qquad ( 4 )$$

where |Γₙ|=tₙ₊₁−tₙ and ρᵢₙ is the transmitted power level of wireless station i in the n^{th} subinterval Γₙ, i.e., ρᵢ(t)=ρᵢₙ for λt ε Γₙ.

Definition 1—Vertex. A transmitted powers vector is a vertex in a time interval if ρᵢ=0 or ρᵢ=Pᵢ for all i=1,2, . . . , M in that time interval.

Proposition 2. In the solution of the optimization problem (4), the transmitted powers vector in subinterval Γᵢ is a vertex, for all i=1,2, . . . ,K.

Proof: Assume there exists at least one subinterval Γⱼ in the optimum solution such that the transmitted power vector is not a vertex. This means at least one of the transmitted power values, ρᵢⱼ is neither 0 nor Pᵢ. Then one can divide Γⱼ into two subintervals such that the new value of ρᵢⱼ in the first λ=1−ρᵢⱼ/Pᵢ portion is ρᵢⱼ¹=0 and the new value of ρᵢⱼ in the second (1−λ) portion is ρᵢⱼ²=Pᵢ; let all the other transmitted power values stay unchanged for both subintervals. Then, the throughput of user i is unchanged in the new power allocation scenario. But for any other user k≠i, one has an increased throughput in the new power allocation scenario since:

$$\begin{matrix}\frac{1}{( {\sum }_{i \neq k , i} {g}_{l} {p}_{lj} + {g}_{i} {P}_{ij} + {I}_{0} ) ( {\sum }_{l \neq k , i} {g}_{l} {p}_{ij} + {I}_{0} )} < \\ \frac{1}{( {\sum }_{l \neq k , i} {g}_{l} {p}_{lj} + {g}_{i} {P}_{ij} + {I}_{0} ) ( {\sum }_{l \neq k , i} {g}_{l} {p}_{lj} + {I}_{0} )} & ( 5 ) \\ ⇒ \frac{1}{{\sum }_{l \neq k , i} {g}_{l} {p}_{lj} + {g}_{i} {p}_{ij} + {I}_{0}} - \frac{1}{{\sum }_{l \neq k , i} {g}_{l} {p}_{lj} + {I}_{0}} < \\ \frac{{p}_{ij}}{{P}_{i}} ( \frac{1}{{\sum }_{l \neq k , i} {g}_{l} {p}_{lj} + {g}_{i} {P}_{i} + {I}_{0}} - \frac{1}{{\sum }_{l \neq k , i} {g}_{l} {p}_{lj} + {I}_{0}} ) & ( 6 ) \\ ⇒ \frac{1}{{\sum }_{l \neq k , i} {g}_{l} {p}_{lj} + {g}_{i} {p}_{ij} + {I}_{0}} < ( 1 - \frac{{p}_{ij}}{{P}_{i}} ) \frac{1}{{\sum }_{l \neq k , i} {g}_{l} {p}_{lj} + {I}_{0}} + \\ \frac{{p}_{ij}}{{P}_{i}} \frac{1}{{\sum }_{l \neq k , i} {g}_{l} {p}_{lj} + {g}_{i} {P}_{i} + {I}_{0}} & ( 7 ) \\ ⇒ \frac{{g}_{k} {p}_{kn} \vert {Γ}_{j} \vert}{{\sum }_{l \neq k , i} {g}_{l} {p}_{lj} + {g}_{i} {P}_{i} + {I}_{0}} < ( 1 - \frac{{p}_{ij}}{{P}_{i}} ) \frac{{g}_{k} {p}_{kn} \vert {Γ}_{j} \vert}{{\sum }_{l \neq k , i} {g}_{l} {p}_{lj} + {I}_{0}} + \\ \frac{{p}_{ij}}{{P}_{i}} \frac{{g}_{k} {p}_{kn} \vert {Γ}_{j} \vert}{{\sum }_{l \neq k , i} {g}_{l} {p}_{lj} + {g}_{i} {P}_{i} + {I}_{0}} & ( 8 ) \\ ⇒ \frac{{g}_{k} {p}_{kn} \vert {Γ}_{j} \vert}{{\sum }_{l \neq k , i} {g}_{l} {p}_{lj} + {g}_{i} {p}_{ij} + {I}_{0}} < λ \frac{{g}_{k} {p}_{kn} \vert {Γ}_{j} \vert}{{\sum }_{l \neq k , i} {g}_{l} {p}_{lj} + {I}_{0}} + \\ ( 1 - λ ) \frac{{g}_{k} {p}_{kn} \vert {Γ}_{j} \vert}{{\sum }_{l \neq k , i} {g}_{l} {p}_{lj} + {g}_{i} {P}_{i} + {I}_{0}} & ( 9 )\end{matrix}$$

Notice that the left-hand side of the inequality (9) is the throughput of user k in Γⱼ in the old power allocation scenario and the right-hand side of the inequality (9) is the throughput of user k in Γⱼ in the new power allocation scenario.

By Proposition 1, the optimization problem (4) becomes:

$${max}_{R ∈ Φ , p ∈ Ψ} H ( 0 , t ) = {max}_{R ∈ Φ} {\sum }_{i}^{} \frac{W}{{κ}_{i}} {\sum }_{n = 1}^{{2}^{M}} \frac{{g}_{i} {\tilde{p}}_{in} \vert {Γ}_{n} \vert}{{\sum }_{j \neq i} {g}_{j} {\tilde{p}}_{jn} + {I}_{0}} \qquad ( 10 )$$

where the vectors Vₙ=(\tilde{ρ}₁ₙ, \tilde{ρ}₂ₙ, . . . , \tilde{ρ}_{Mn}) ⊂ Ω, n=1,2, . . . , 2^{m} are all distinct, and where Ω denotes the set of all possible vertices. Also, without loss of generality, the partition is renamed in which the vertex (\tilde{ρ}₁ₙ, \tilde{ρ}₂ₙ, . . . , \tilde{ρ}_{Mn}) is employed, to Γₙ, for all n=1,2, . . . , 2^{M}. Unlike the original optimization problem (over the infinite set Ψ), after restricting the solution set considerably (to the finite set Ω), one can now solve the optimization problem with linear optimization techniques like the linear programming method. The output of the optimization algorithm will be the Γ₁, . . . Γ₂_{^{M}} values.

Let Γ=(|Γ₁|, |Γ₂|, . . . , |Γ₂_{^{M}}|) and A=((αᵢⱼ)) where αᵢⱼ=

$$\frac{W}{{κ}_{i}} \frac{{g}_{i} {\tilde{p}}_{ij}}{{\sum }_{k \neq i} {g}_{k} {\tilde{p}}_{kj} + {I}_{0}}$$

then the optimization problem can be written as:

maximize 1·A·Γ (the inequalities are componentwise): AΓ≧ρ (11)

Notice that although it has been found that the throughput maximizing scheduling for the duration (0,t), this scheduling will satisfy all the QoS requirements of each wireless user, but the extra capacity will be transferred to users with better channel gains. This will cause unfairness among wireless users and is impractical. If one introduces the additional condition that each user will share the extra capacity proportional to their QoS requirements, then it is easy to see that the throughput maximization problem is equivalent to finding the minimum feasible value t, by which all the QoS requirements are satisfied. Therefore, one transforms the throughput optimization problem to the following minimization problem:

$$minimize {\sum }_{i = 1}^{{2}^{M}} \vert {Γ}_{i} \vert with the constraints ( the inequalities are componentwise ) \text{:} A Γ \geq ρ \qquad ( 12 )$$

It is not hard to see that the inequality in the constraint above can be replaced by equality since the optimum solution will satisfy the rate requirements with equality. Let Γ*=(|Γ₁*|,|Γ₂*|, . . . ,|Γ₂^{^{ij}}*|) be the solution to the last optimization problem which can be solved by linear optimization methods like linear programming. Some details may be skipped, but as a result of the optimization problem, the optimum solution r* will have at least ₂^{M}−M zero values and at most M non-zero values. The efficient linear programming techniques like simplex method can be used in order to achieve fast results. Since in the algorithm one would only have M basic feasible solutions at any iteration, one will have O(M2^{M}) worst-case time and O(M²) best-case time. The memory need is only O(M²).

Power Allocation Scheme in Uplink

In the light of the previous sections, one can construct the power allocation and scheduling scheme. The proposed power allocation scheme works as follows and is described with reference to FIG. 4. As soon as one of the measured values of q(t) (as a result of a change in g(t)) or I₀ changes, the base station will run the optimization algorithm and will assign the powers to the wireless stations according to the optimization output, meaning for a period of |₁*|, the powers vector V₁ will be assigned to the wireless stations, then for a period of |₂*|, the powers vector V₂ will be assigned and so forth. As soon as the duration |₂_{^{M}}*| where the powers vector V₂_{^{M}} is assigned elapses, the base station will again start assigning the powers vector V₁ for a duration of |Γ₁*|, and then again will assign the powers vector V₂ for a duration of |Γ₂*| and so forth until either the value of g(t) or I₀ changes. Remember that there are only at most M non-zero Γᵢ* values, meaning that there will be a time-division round robin between at most M vertices. Also notice that any variation of power allocations will give the same result as long as the time durations have the same ratios with the original |Γₙ*|'s, i.e., instead of assigning the powers vector Vₙ for durations |Γₙ*|'s, one can assign the powers vector Vₙ for durations of |Γₙ′|'s as long as

$$\frac{\vert {Γ}_{n}^{*} \vert}{\vert {Γ}_{n}^{′} \vert} = c$$

for all n=1, . . . , 2^{M}, where c ⊂Γ is a constant. This is particularly important since by this property one can make the subintervals as small as practically possible (and repeat the scheme until one of the channel gains or I₀ changes and a new optimization is calculated) so that one can ensure the objective values. The application reordering of the subintervals will not change any results either.

Another version of the power allocation algorithm can be designed by limiting the maximum received power level from each wireless station, i.e., put a limitation to the transmission power of the wireless station, even if it is capable of transmitting with higher values. This will let one limit the power consumption, and therefore limit the intercell interference introduced to other cells. In simulations, one can use the value 36 and 16 times the background noise level at the base station as the maximum received power limitation for simulation 1 and simulation 2, respectively.

Therefore, the application specifics highly depend on the design constraints at hand. With a bottom to up design circumstance, the design can target to follow the fast-fading fluctuations in the channel gains. In third generation wireless proposals, the uplink closed-loop power control bits has a rate changed from 800 Hz to 2200 Hz. That frequency has been shown to cope with the fast raleigh fading of the wireless connections. Therefore, similar types of pilot bits can be used to assign maximum power (or the limited maximum value) or zero power to the wireless station by the base station to accomplish the novel power allocation scheme.

As will be discussed later, the overlay of this algorithm is only feasible to track the slow fading characteristics of the wireless channel and therefore leaving the correction of smaller fast fading fluctuations to traditional perfect power control.

It is also important to notice the following. In the third generation wireless systems one individual wireless station is allowed to have several connections and channels active simultaneously. For calculation purposes, any such scenario can be approached as a system with wireless users with only single connections.

Power Allocation in Downlink

So far one has established the power allocation/scheduling scheme in the uplink. Although the dynamics of the system and the strategy looks similar to our analysis in uplink, there are subtle and important differences. One must notice that unlike having a single base station, in the downlink the number of receivers is equal to the number of wireless stations. Additionally, each signal has a different gain at different wireless stations. Therefore, if one abuses the notation such that one keeps the same letter for the downlink counterpart of the variable in the uplink, the SNR equation at the wireless station i becomes:

$${( \frac{{E}_{b}}{{N}_{0}} )}_{i} = \frac{W}{{R}_{i}} \frac{{g}_{i} {p}_{i}}{{\sum }_{j \neq i} {g}_{j} {p}_{j} + {I}_{i}} = \frac{W}{{R}_{i}} \frac{{p}_{i}}{{\sum }_{j \neq i} {p}_{j} + \frac{{I}_{i}}{{g}_{i}}} , ∀ i ∈ \{ 1 , 2 , … , M \} \qquad ( 13 )$$

The last equation follows because gᵢ=gⱼ for all j ⊂{1,2, . . . , M} in a downlink from the base station to the wireless station. Iᵢ replaces I₀ since unlike uplink, in downlink the background noise and the intercell interference caused by other cells are not the same for different wireless stations. This is the fact that one is going to exploit to maximize throughput.

By omitting some steps similar to the analysis of the uplink, the total throughput maximization problem of the cell in the downlink becomes:

$${max}_{R ∈ Φ p ∈ Y ( B )} H ( 0 , t ) = {max}_{R ∈ Φ p ∈ Y ( B )} {\sum }_{i}^{} \frac{W}{{κ}_{i}} {\sum }_{n = 1}^{K} \frac{{p}_{in} \vert {Γ}_{n} \vert}{{\sum }_{j \neq i} □ {p}_{jn} + \frac{{I}_{i}}{{g}_{i}}} \qquad ( 14 )$$

where the set Υ (α)={p|0≦p≦P and 1·p=α} and B is the maximum total power the base station can transmit.

Definition 2. Vertex-restricted-by-B: A transmitted powers vector is a vertex-restricted-by-B in a time interval if ρᵢ=0 or ρᵢ=Pᵢ for all i=* 1,2, . . . ,M except one i=κ ⊂ {1,2, . . . , M} for which 0≦ρ_{κ}≦Pᵢ and Σᵢρᵢ=B in that time interval.

Proposition 2. In the solution of the optimization problem (14), the transmitted powers vector in subinterval Γᵢ is either a vertex or a vertex-restricted-by-B, for all i=1,2, . . . ,M.

Proof. Assume there exists at least one subinterval Γⱼ in the optimum solution such that the transmitted power vector is not a vertex nor a vertex-restricted-by-B. This means at least two of the transmitted power values, ρᵢⱼ is neither 0 nor Pᵢ and ρₖⱼ is neither 0 nor Pₖ. Assume ρᵢⱼ>ρₖⱼ without loss of generality. Then one can divide Γⱼ into two subintervals such that the new value of ρᵢⱼ is ρᵢⱼ¹=ρᵢⱼ−q>0 and the new value of ρₖⱼ is ρₖⱼ¹=ρₖⱼ+q in the first λ portion of Γⱼ and the new values are ρᵢⱼ²=ρᵢⱼ−q and ρₖⱼ²=ρₖⱼ+q in the remaining 1−λ portion of Γⱼ . Let all the other transmitted power values stay unchanged for both subintervals. Then the throughput of the downlinks other than i and k are unchanged in the new power allocation scenario. But for the i^{th} and k^{th} downlink one has an increased throughput in the new power allocation scenario if

$$λ ∈ ( \frac{a + {b}_{1} - q}{2 ( a + {b}_{1} )} , \frac{c + {b}_{2} + q}{2 ( c + {b}_{2} )} ) where a = {p}_{ij} , {b}_{1} = ( {\sum }_{n \neq i , k} {p}_{nj} ) + \frac{{I}_{i}}{{g}_{i}} , {b}_{2} = ( {\sum }_{n \neq i , k} {p}_{nj} ) + \frac{{I}_{k}}{{g}_{k}} and c = {p}_{kj} since : \\ λ < \frac{c + {b}_{1} + q}{2 ( c + {b}_{1} )} ⇒ λ \frac{a - q}{{b}_{1} + c + q} + ( 1 - λ ) \frac{a + q}{{b}_{1} + c - q} > \frac{a}{c + {b}_{1}} \qquad ( 15 )$$

where the steps in between are straightforward therefore are skipped. Multiplying each side of the last inequality by |Γⱼ| proves that the throughput of the i^{th} downlink is improved in the new scenario. Similarly

$$λ > \frac{a + {b}_{2} - q}{2 ( a + {b}_{2} )} ⇒ λ \frac{c + q}{a + {b}_{2} - q} + ( 1 - λ ) \frac{c - q}{a + {b}_{2} + q} > \frac{c}{a + {b}_{2}} \qquad ( 16 )$$

Multiplying each side of the last inequality by |Γⱼ| proves that the throughput of the k^{th} downlink is improved in the new scenario. Finally one can easily verify that

$$\frac{a + {b}_{1} - q}{2 ( a + {b}_{1} )} < \frac{c + {b}_{2} + q}{2 ( c + {b}_{2} )}$$

to complete the proof.

In the downlink, the maximum allowed power for a single connection can become the maximum transmitting power of the base station (in that case the optimum scheduling is known to be pure TDMA). But for real-time connections with latency requirements, there will be a rate restriction enforcing a soft upper bound on the transmitting powers, and therefore justifying the assumptions in the proof above.

By proposition 2, the optimization problem in (14) becomes:

$${max}_{R ∈ Φ , p ∈ Y ( B )} H ( 0 , t ) = {max}_{R ∈ Φ} {\sum }_{i}^{} \frac{W}{{k}_{i}} {\sum }_{n = 1}^{L} \frac{{\tilde{p}}_{in} \vert {Γ}_{n} \vert}{{\sum }_{j \neq i} \cdot {\tilde{p}}_{jn} + \frac{{I}_{i}}{{g}_{i}}} \qquad ( 17 )$$

where the vectors Yₙ=(\tilde{ρ}₁ₙ, \tilde{ρ}₂ₙ, . . . , \tilde{ρ}_{Mn}) ⊂ φ, n=1,2, . . . ,L are all distinct, and φ so denotes the set of all possible vertices and vertices-restricted-by-B. Also, without loss of generality, one again renamed the partition in which the vertex (\tilde{ρ}₁ₙ, \tilde{ρ}₂ₙ, . . . , \tilde{ρ}_{M n}) is employed, to Γₙ, for all n=1,2, . . . ,L. Unlike the original optimization problem (over the infinite set Υ(B)), after restricting the solution set considerably (to the finite set so), one can now solve the optimization problem with linear optimization techniques like the linear programming method. The output of the optimization algorithm will be the Γ₁, . . . ,Γ_{L} values.

Let Γ=(|Γ₁|,|Γ₂|, . . . ,|Γ_{L}|) and A=((αᵢⱼ)) where αᵢⱼ=

$$\frac{W}{{κ}_{i}} \frac{{\tilde{p}}_{in}}{{\sum }_{j \neq i} {\tilde{p}}_{jn} + \frac{{I}_{i}}{{g}_{i}}}$$

then the optimization problem can be written as:

maximize 1AΓ with the constraints (the inequalities are componentwise): AΓ≧ρ (18)

Notice that although one has found the throughput maximizing scheduling for the duration (0, t), this scheduling will satisfy all the QoS requirements of each wireless user but the extra capacity will be transformed to users with better channel gains. This is unfair and unpractical. If one introduces the additional condition that each user will share the extra capacity proportional to their QoS requirements, then it is easy to see that the throughput maximization problem is equivalent to finding the minimum feasible value t, by when all the QoS requirements are satisfied. Therefore, one transforms the throughput optimization problem to the following minimization problem:

$$minimize {\sum }_{i = 1}^{{2}^{M}} \vert {Γ}_{i} \vert with the constraints : A Γ \geq ρ \qquad ( 19 )$$

It is not hard to see that the inequality in the constraint above can be replaced by equality since the optimum solution will satisfy the rate requirements with equality. Let Γ*=(|Γ*|, |Γ₂*|, . . . , |Γ_{L}*|) be the solution to the last optimization problem which can be solved by linear optimization methods like linear programmning. One skips some details but as a result of the optimization problem, the optimum solution Γ* will have at least L-M zero values and at most M non-zero values. The efficient linear programming techniques like simplex method can be used in order to achieve fast results. Since in the algorithm one would only have M basic feasible solutions at any iteration, one will have O(ML) worst-case time and O(M²) best-case time. The memory need is only O(M²).

Power Allocation Scheme in Downlink

The proposed power allocation scheme will work as follows: As soon as one of the measured values of q(t) (as a result of a change in g(t)) or Iᵢ changes, the base station will run the optimization algorithm and will assign the powers to the connections to the wireless stations according to the optimization output, meaning for a period of |Γ₁*, the powers vector Y₁ will be assigned to the downlink connections, then for a period of |Γ₂*|, the powers vector Y₂ will be assigned and so forth. As soon as the duration |Γ_{L}*| where the powers vector Y_{L} is assigned elapses, the base station will again start assigning the powers vector Y₁ for a duration of |Γ₁*|, and then again will assign the powers vector Y₂ for a duration of |Γ₂*| and so forth until either the value of g(t) or one of the Iᵢ's change. Remember that there are only at most M non-zero |Γ₁*| values, meaning that there will be a time-division round robin between at most M vertices and/or vertices-restricted-by-B. Also notice that any variation of power allocations will give the same result as long as the time durations have the same ratios with the original |Γₙ*|'s, i.e., instead of assigning the powers vector Yₙ for duration |Γₙ*|'s, one can assign the powers vector Yₙ for durations of |Γₙ*|'s as long as

$$\frac{\vert {T}_{n}^{*} \vert}{\vert {Γ}_{n}^{′} \vert} = c$$

for all n=1, . . . , L where c ε [symbol] is a constant. This is particularly important since by this property one can make the subintervals as small as practically possible (and repeat the scheme until one of the channel gains or Iᵢ values change and a new optimization is calculated) so that one can ensure the objectives values. Also notice that the application reordering of the subintervals will not change any results either.

Conclusion for downlink about the application of the algorithm to practical systems are parallel to the one concluded from the analysis for the uplink.

Inexact Linear Programming with Set-Inclusive Constraints

Introduction

In a practical system the channel gain estimations of the network may not be perfect. If the estimation of the channel gain is different than the actual value, the algorithm of the present invention will cause some connections to fail to satisfy their QoS guarantees. If the real channel gain is lower than the estimated value, the QoS of the channel will suffer and the connection may eventually be lost. In order to increase the robustness, the algorithm can be modified so that the QoS requirements will be met even if they are off by some amount. To serve this aim, one uses inexact linear programming.

Inexact Linear Programming

In an inexact LP, the usual convex inequalities, AΓ≦ρ are replaced by the constraint that the sum of a finite number of convex sets is contained in another convex set, in this case, one will restrict the later to the special form of a polyhedral convex set, i.e.:

maximize 1AΓ with the constraints

(the inequalities are componentwise):

Γ₁G₁+Γ₂G_{2+. . .+Γ}₂_{^{M}}G₂_{^{M}}≧ρ and Γⱼ≧0 (20)

where Gⱼ is a convex set containing aj, the j^{th} column of the matrix A.

In generalized linear programming there is a freedom to choose any vector aⱼ ∈ Gⱼ for each j to maximize the objective function, i.e.,

maximize 1·A·Γ with the constraints:

Γ₁a₁+Γ₂a₂+. . .+Γ₂_{^{M}}a₂_{^{M}}≧ρ and Γⱼ≧0, aⱼ ∈ Gⱼ (21)

In the generalized LP the activity vectors aⱼ are decision quantities as are the Γ's. But Γᵢ is feasible for (2) if and only if Γ₁a₁+Γ₂a₂+Γ₂_{^{M}}a₂_{^{M}}≦ρ and Γᵢ≧0 for all possible sets of activity vectors.

If the convex sets Gᵢ's are equal to single vector, then the inexact LP coincides with regular LP. Therefore, the inexact LP applies to problems where the constraint vectors aⱼ's are not exactly known but are known to be in a convex set Gⱼ.

Proposition 3. S={Γ | Γ is feasible for (20)} is a convex set.

Proof. Let (\tilde{Γ}₁, \tilde{Γ}₂, . . . , \tilde{Γ}₂_{^{M}}) and (\hat{Γ}₁, \hat{Γ}₂, . . . , \hat{Γ}₂_{^{M}}) ∈ S and for any aⱼ∀ⱼ=1, . . . , n, and λ ∈ (0, 1) we have s₁=\tilde{Γ}₁a₁+\tilde{Γ}₂a₂+. . .+\tilde{Γ}₂_{^{M}}a₂_{^{M}} and s₂=\hat{Γ}₁a₁+\hat{Γ}₂a₂+. . .+\hat{Γ}₂_{^{M}}2₂_{^{M}} ∈ S, so (λ\hat{Γ}₁+(1−λ)\tilde{Γ}₁)a₁+(λ\hat{Γ}₂+(1−λ)\tilde{Γ}₂)a₂+ . . . +(λ\hat{Γ}₂_{^{M}}+(1−λ)\tilde{Γ}₂_{^{M}})a₂_{^{M}}=λs₂+(1−λ)s₁≦ρ, which means λs₂+(1−λ)s₁ ∈ S.

Definition 3. The support functional δ(z | Gⱼ) of the convex set Gⱼ is equal to inf_{aj∈G}_{ⱼ} z·aⱼ.

For each j define the vector \overline{a}j where its j^{th} entry is equal to \hat{δ} (eᵢ | Gⱼ)=infₐ_{ⱼ}_{∈G}_{ⱼ} aᵢⱼ. If the set Gⱼ includes a vector who has an entry equal to −∞, say the i^{th} entry, then \hat{δ} (eᵢ | Gⱼ)=−∞ and therefore Γ₁G₁+Γ₂·G₂+. . .+Γ₂_{^{M}}·G₂_{^{M}}≧ρ necessarily implies that Γⱼ=0. Therefore one can omit the activity set Gⱼ from the LP without loss of any generality. Therefore one assumes that \hat{δ} (eᵢ | Gⱼ)>−∞ for all i and j. Same restriction is automatically achieved if one assumes that the sets {Gⱼ} are compact.

In the following artificial LP problem:

maximize 1\overline{A}Γ with the constraints:

Γ₁\overline{a}₂+. . .+Γ₂_{^{M}}\overline{a}₂_{^{M}}≧ρ and Γⱼ≧0 (22)

The optimal solution to (22) is also the optimal solution to (20). Define the set H, as the set of all possible matrices formed from the convex sets Gⱼ's, i.e.:

H={(a₁, a₂, . . . , aₙ)|aᵢ ∈Gᵢ∀i} (23)

After this definition, it is appropriate to denote that Γ is a feasible solution to problem (20) if and only if A·Γ≧ρ, ∀A ∈ H and Γ≧0.

Claim 1: If \overline{Γ} is a feasible solution to (22) (the artificial ordinary linear optimization problem), then Γ is a feasible solution for (20 (the inexact linear optimization problem).

Proof. Let \overline{Γ} be a feasible solution to our artificial LP (22), then since \overline{A Γ}≧ρ and \overline{Γ}≧0, and by construction we have A≧\overline{A}. But then \overline{Γ} is a feasible solution for our original inexact LP (20) since A\overline{Γ}≧\overline{Γ}≧ρ for all A ∈ H.

Conversely, if \overline{Γ} is a feasible solution for (20), then, \overline{Γ}₁aᵢ₁+ . . . +\overline{Γ}₂_{^{M}}aᵢ₂_{^{M≧ρ}}ᵢ (where ρᵢ is the i^{th} component of the vector ρ), a_{j ∈ G}ⱼ, for i=1, 2, . . . , M. Therefore, for all i=1, 2, . . . , M:

$${\overline{Γ}}_{1} {inf}_{{a}_{1} ∈ {K}_{1}} {a}_{i1} + {\overline{Γ}}_{2} {inf}_{{a}_{2} ∈ {K}_{2}} {a}_{i2} + … + {\overline{Γ}}_{{2}^{M}} {inf}_{{a}_{{2}^{M}} ∈ {K}_{{2}^{M}}} {a}_{{i2}^{M}} \geq {ρ}_{i} , \qquad ( 24 )$$

which is indeed equivalent to \overline{Γ} being a feasible solution to (22).

Corollary 1. Notice that the immediate result of the lemma above is that the sets of the feasible solutions to the two problems are identical, this means that the solution of (20) can be directly obtained by solving (22), which is an ordinary linear optimization problem.

The Algorithm with Inexact Estimates

The inexact linear programming method is put into use by first assuming that the engine of the present invention does not have the exact values of the channel gains and the interference values, but rather inaccurate estimates of those variables. Therefore the real values of the estimated variables are only guaranteed to be within a neighborhood of the estimate. Therefore one has:

gᵢ ∈ [ĝᵢ−Δᵢ, ĝᵢ+Δ] for all i=1, . . . ,M and I₀ ∈ [Î₀−Δ_{I}, Î₀+Δ_{I}] (25)

These relations translate into the following condition that aᵢⱼ is guaranteed to be in the interval θᵢⱼ where the θᵢⱼ is defined by

$${θ}_{ij} = [ \frac{W}{{κ}_{i}} \frac{( {\hat{g}}_{i} - {Δ}_{i} ) {\tilde{p}}_{ij}}{{\sum }_{k \neq i} ( {\hat{g}}_{k} + {Δ}_{k} ) {\tilde{p}}_{kj} + ( {\hat{I}}_{0} + {Δ}_{l} )} , \frac{W}{{κ}_{i}} \frac{( {\hat{g}}_{i} + {Δ}_{i} ) {\tilde{p}}_{ij}}{{\sum }_{k \neq i} ( {\hat{g}}_{k} - {Δ}_{k} ) {\tilde{p}}_{kj} + ( {\hat{I}}_{0} - {Δ}_{l} )} ] = \qquad ( 26 )$$

If one defines the set Gⱼ's, j=1, 2, . . . , M such that

Gⱼ={(a₁ⱼ, a₂ⱼ, . . . , a_{Mj})^{T}|∀iaᵢⱼ∈θᵢⱼ} (27)

Then to satisfy the individual connection requirements under the method of the present invention, no matter what channel gains and interference values one gets (given that they will lie within their allowed intervals), one has to solve (20) with the new values of Gⱼ's. But by claim 1, solving that LP is equivalent to solving the following artificial LP:

maximize \overline{A}·Γ with the constraints:

Γ₁\overline{a}₁+Γ₂\overline{a}+. . .+Γ₂_{^{M}}\overline{a}₂_{^{M≧ρ and Γ}}ⱼ≧0 (28)

where the vectors \overline{a}ⱼ=(\overline{a}_{1j, \overline{a}}₂ⱼ, . . . , \overline{a}_{Mj}), the matrix \overline{A}=(\overline{a}_{1, \overline{a}a, . . . , \overline{a}}ₐ_{^{M}}) and

$${\overline{a}}_{ij} = \hat{δ} ( {e}_{i} \vert {G}_{j} ) = {inf}_{{a}_{j} ∈ {G}_{j}} {a}_{ij} = {inf}_{{a}_{ij} ∈ {θ}_{ij}} {a}_{ij} = {W}_{{κ}_{i}} \frac{( {\hat{g}}_{i} - {Δ}_{i} ) {\tilde{p}}_{ij}}{{\sum }_{k \neq i} ( {\hat{g}}_{k} + {Δ}_{k} ) {\tilde{p}}_{kj} + ( {\hat{I}}_{0} + {Δ}_{l} )} \qquad ( 29 )$$

One can assign the desired values to Δᵢ's and Δ_{I} and calculate the output of the algorithm, namely, the vector mathbfΓ. But for the sake of analysis, one assumes that one can foresee and guarantee estimation of the channel gains and the intercell interference values with the same percentage accuracy, i.e.:

$$\frac{{Δ}_{1}}{{\hat{g}}_{1}} = \frac{{Δ}_{2}}{{\hat{g}}_{2}} = … = \frac{{Δ}_{M}}{{\hat{g}}_{M}} = \frac{{Δ}_{l}}{{\hat{I}}_{0}} = c \qquad ( 30 )$$

Then,

$${\overline{a}}_{ij} = \frac{W}{{κ}_{i}} \frac{( {\hat{g}}_{i} - c {\hat{g}}_{i} ) {\tilde{p}}_{ij}}{{\sum }_{k \neq i} ( {\hat{g}}_{k} + c {\hat{g}}_{k} ) {\tilde{p}}_{kj} + ( {\hat{I}}_{0} + c {\hat{I}}_{0} )} = \frac{1 - c}{1 + c} \frac{W}{{κ}_{i}} \frac{{\hat{g}}_{i} {\tilde{p}}_{ij}}{{\sum }_{k \neq i} {\hat{g}}_{k} {\tilde{p}}_{kj} + {\hat{I}}_{0}} = \frac{1 - c}{1 + c} {\hat{a}}_{ij} \qquad ( 31 )$$

and therefore, \overline{A}=

$$\frac{1 - c}{1 + c}$$

Â, where Â=(â₁, â₂, . . . , â₂_{^{M}}).

Conclusion

Assuming one has the channel gain estimates, ĝ₁, . . ., ĝ_{M}, and an estimate for the intercell interference value, Î₀, and assuming that one knows that the estimates are guaranteed to be within 5% of the estimated values, the algorithm calculates the output, Γ, with the input set ĝ₁, . . ., ĝ_{M}, Î₀. But the quality of service requirements will not be satisfied unless one is lucky and gets exactly the estimated values. If one wants the outcome scheduling to be optimum and satisfy the individual quality of service requirements, as long as the estimation errors are within the 5% error margins, then the algorithm should calculate Γ as if the rate requirements of each of the connections were higher by a multiple of

$$\frac{1 + c}{1 - c} = \frac{1 + 0.05}{1 - 0.05} ≅ 1.105$$

and implement the modified output. But this will result in an output of Γ′=

$$\frac{1 + c}{1 - c} Γ ,$$

where Γ is the solution to the original situation where one was not seeking any guarantees. So if (30) is satisfied, one has a very simple modification to the algorithm of the present invention and that is:

run the algorithm with the input set ĝ₁, . . ., ĝ_{M}, Î₀ to get output Γ−implement Γ′=

$$\frac{1 + c}{1 - c} Γ$$

where c is the percentage error that can be tolerated for estimates.

Table 1 tabulates how the time requirement increases with respect to the error margin tolerance.

| Estimation | | | | | | | | |
|---|---|---|---|---|---|---|---|---|
| error | 1% | 3% | 5% | 10% | 20% | 25% | 33% | 50% |
| Γ′/Γ | 1.020 | 1.062 | 1.105 | 1.222 | 1.500 | 1.667 | 2.000 | 3.000 |

As one comes closer to 100% estimate error range, the Γ′/Γ value reaches ∞ which makes sense. The solution of (22) actually provides an ultraconservative strategy for the stochastic linear program of the form (20). If one has different estimation error percentages for the different connections, i.e., the better channel may be estimated more accurately, then those values should be used to calculate the corresponding \overline{a}ᵢⱼ values. This will improve the performance loss for rate requirement guarantees.

Look-up Table Alternative for Processing Power Constrained Modem Chips

As the wireless technologies move forward, so does the processing power of the modem and DSP chipsets that are used for wireless communications. Especially at the base station, the cost of having a more powerful chipset is insignificant compared to the other inherent costs of base stations, such as rent and maintenance costs. Therefore, implementing the present invention in real-time is an alternative, but for less processing powered modem chips we introduce a look-up table alternative approach. The idea is that to have all the calculation results in a matrix like table, so that the base station, depending on the channel gain estimates and intercell interference estimate, can look up in the table and can find the pre-calculated scheduling scheme in the look-up table. Therefore, this look-up table should include all the possible combinations of outcomes (in terms of the estimated value) and the corresponding schedulings. The calculations will be done offline, and therefore the calculation speed issue will be decoupled from implementation concerns.

Obviously, in a look-up table approach, the size of the look-up table is the foremost concern in terms of implementability.

It may be assumed that the channel gains vector (or alternatively, the received powers vector) and the intercell interference estimate are quantizised into k levels.

The method and system of the invention may be designed to serve a maximum number of Mₘₐₓ wireless stations at any given time with k levels of quantization. A memory may be provided that is capable of storing

$$( k + {{M}_{k}}_{max} ) - 1$$

schedulings.

The method and system of the present invention always outperforms the traditional “perfect” power control simply because of proposition 1. One may argue that the proposed scheme might be less power efficient since the wireless stations transmit only with maximum power (or the modified maximum power when we limit the maximum received power at the base station from a single user). This is important because not only is it vital for longer battery life but is also important for causing less interference to the neighboring cells. In the method and system of the present invention, possibly not all the users are transmitting at the same time. Simulations indicate that this effect which favors less average power consumption, outweighs the fact that the wireless stations are transmitting with more power when they transmit. Actually the results of simulations show that the invention has some power advantage which can be further translated into even higher total throughput and therefore higher capacity.

Another advantage of the method and system of the present invention is a fortunate result of the on-off type nature of the power allocation scheme. This type of modulation is proven to be very beneficial for battery conservation since this type of behavior allows the batteries to naturally recharge in the off periods.

The power allocation of the method and system of the present invention, unlike the traditional “perfect” power controlled CDMA system, has QoS guarantees and rate guarantees built into it. This fact is emphasized even more when wireless stations have different QoS requirements.

In order to have a complete multiple access scheme, one should address the admission control mechanism which could be designed for the power control method of the present invention. Although it is believed that a simple admission control scheme with an undynamic threshold would work, a more sophisticated but more capacity efficient dynamic admission control is possible.

Similarly, handoff algorithms are not straightforward especially with soft-handoffs. Allowing a single wireless user to be connected to several base stations simultaneously will introduce new constraints to the optimization algorithm of the present invention and therefore may modify the power allocation scheme. An efficient and robust handoff algorithm suitable for our proposed scheme can be designed.

The method and system of the present invention are dependent (though the throughput is robust) on the relative value of I₀ compared to the maximum received powers of the wireless stations. Wireless users transmitting all at the same time as I₀ gets larger and coincides with regular TDMA with maximum transmitting power allocations as I₀ approaches 0. Methods may be used to predict the I₀ value both in uplink and downlink. Similarly, predicting the received powers are also important.

A limitation to the maximum allowed received power at the base station may be used. This cut-off value might be dependent on the values of background noise and the intercell interference measures. Therefore, the optimum cut-off value might be a function dependent on I₀ and possible dependent on the channel gains of that cell.

The method and system of the present invention may be implemented with a simple software overlay onto existing CDMA systems, so that only a simple base station software upgrade is necessary (i.e., no hardware nor software upgrades are necessary at wireless stations). This, however, might turn out to be too optimistic and some updates at the wireless stations might be unavoidable.

Synchronization is important to the method and system of the present invention. A quite accurate synchronization of the system which can be achieved via the GPS clock is assumed. The synchronization should be done within the time periods of a chip duration. The is already an objective of any CDMA system.

One of the advantages of the method and system of the present invention is that the algorithm only needs to be calculated at the base station both for the uplink and the downlink. But this calculation needs to be done very fast. The optimization algorithms are very efficient and the processing power already deployed at the base stations should be powerful enough for the calculations especially with increased number of active users. One may introduce approximations to the exact optimization algorithm with methods like rounding the values of the channel gains to specific values so that there are not many different channel gain values. Alternatively, alternative methods like pre-calculated look-up tables at the base stations may be provided.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for allocating transmitting power and scheduling packets in a first wireless cell of a wireless communication system having a plurality of wireless cells to improve throughput in the first wireless cell, each of the wireless cells including a base station and a plurality of wireless stations, the method comprising:
a) for each preselected wireless station of the first wireless cell, determining a channel gain;
b) determining intercell interference experienced within the first wireless cell caused by the other wireless cells;
c) determining a power allocation and scheduling scheme based on the determined channel gains and the determined intercell interference; and
d) assigning transmitting power values and corresponding transmitting time durations within the first wireless cell based on the scheme to improve total throughput in the first wireless cell.

2. The method as claimed in claim 1, wherein each of the wireless stations has quality of service requirements and wherein the step of determining the scheme is also based on the quality of service requirements of the preselected wireless stations in the first wireless cell.

3. The method as claimed in claim 1, further comprising determining background noise experienced within the first cell wherein the step of determining the scheme is also based on the determined background noise.

4. The method as claimed in claim 1, further comprising repeating steps a)-d) when at least one of the channel gains or the intercell interference changes by a predetermined amount to obtain a new power allocation and scheduling scheme, wherein the step of assigning is based on the new scheme.

5. The method as claimed in claim 1, further comprising repeating step d) as long as the channel gains and the intercell interference do not change by a predetermined amount or until the topology of the connections changes.

6. The method as claimed in claim 1, wherein the transmitting power values are less than maximum power levels to limit intercell interference introduced to other wireless cells of the system.

7. The method as claimed in claim 1, wherein the step of determining the scheme includes the step of calculating the scheme.

8. The method as claimed in claim 1, wherein the step of determining the scheme includes the step of selecting the scheme from a plurality of precalculated stored schemes.

9. The method as claimed in claim 1, wherein each of the determined channel gains is an estimate.

10. The method as claimed in claim 1, wherein the determined intercell interference is an estimate.

11. The method as claimed in claim 1 wherein the step of determining a channel gain for each preselected wireless station of the first wireless cell is based on power received at the base station of the first wireless cell.

12. The method as claimed in claim 1, wherein the step of determining intercell interference includes the step of determining intercell interference experienced by the base station of the first wireless cell.

13. The method as claimed in claim 1, wherein the step of determining intercell interference includes the step of determining intercell interference experienced by the preselected wireless stations of the first wireless cell.

14. A system for allocating transmitting power and scheduling packets in a first wireless cell of a wireless communication system having a plurality of wireless cells to improve throughput in the first wireless cell, each of the wireless cells including a base station and a plurality of wireless stations, the system comprising:
means for determining a channel gain for each preselected wireless station of the first wireless cell;
means for determining intercell interference caused by the other wireless cells;
means for determining a power allocation and scheduling scheme based on the channel gains and the determined intercell interference; and
means for assigning transmitting power values and corresponding transmitting time durations within the first wireless cell based on the scheme to improve total throughput in the first wireless cell.

15. The system as claimed in claim 14, wherein each of the wireless stations has quality of service requirements and wherein the means for determining the scheme determines the scheme also based on the quality of service requirements of the preselected wireless stations in the first wireless cell.

16. The system as claimed in claim 14, fuirther comprising means for determining background noise experienced in the first wireless cell wherein the means for determining the scheme determines the scheme also based on the determined background noise.

17. The system as claimed in claim 14, wherein at least one of the channel gains or the intercell interference changes by a predetermined amount, and wherein the means for determining the scheme determines a new power allocation and scheduling scheme based on the channel gains and the intercell interference and wherein the means for assigning assigns transmitting power values and corresponding transmitting time durations based on the new scheme.

18. The system as claimed in claim 14, wherein the means for assigning assigns the transmitting power values and corresponding transmitting time durations as long as each of the channel gains and the intercell interference do not change by a predetermined amount or until the topology of the connections changes.

19. The system as claimed in claim 14, wherein the transmitting power levels are less than maximum power levels to limit intercell interference introduced to other wireless cells of the system.

20. The system as claimed in claim 14, wherein the means for determining the scheme includes means for calculating the scheme.

21. The system as claimed in claim 14, wherein the means for determining the scheme includes means for selecting the scheme from a plurality of precalculated stored schemes.

22. The system as claimed in claim 14, wherein each of the determined channel gains is an estimate.

23. The system as claimed in claim 14, wherein the intercell interference is an estimate.

24. The system as claimed in claim 14, wherein the means for determining a channel gain for each of the preselected wireless stations of the first wireless cell determines channel gains based on power received at the base station of the first wireless cell.

25. The system as claimed in claim 14, wherein the means for determining intercell interference determines intercell interference experienced by the base station of the first wireless cell.

26. The system as claimed in claim 14, wherein the means for determining intercell interference determines intercell interference experienced by the preselected wireless stations of the first wireless cell.

27. A method for allocating transmitting power and scheduling packets in one or more selected cell sites of a wireless network having a plurality of cell sites to improve total achievable throughput, and therefor capacity, of the entire network, each of the cell sites including a base station and a plurality of wireless stations, the method comprising:
a) for each preselected wireless station of the one or more selected cell sites, determining a channel gain;
b) determining intercell interference experienced within the one or more selected cell sites caused by the other cell sites of the network;
c) determining one or more power allocation and scheduling schemes based on the determined channel gains and the one or more determined intercell interferences; and
d) assigning transmitting power values and corresponding transmitting time durations within the one or more selected cell sites based on the one or more schemes, respectively, to improve total achievable throughput, and therefor capacity, of the entire network.

28. A system for allocating transmitting power and scheduling packets in one or more selected cell sites of a wireless network having a plurality of cell sites to improve total achievable throughput, and therefor capacity, of the entire network, each of the cell sites including a base station and a plurality of wireless stations, the system comprising:
means for determining a channel gain for each preselected wireless station of the one or more selected cell sites;
means for determining intercell interference caused by other cell sites of the network;
means for determining one or more power allocation and scheduling schemes based on the channel gains and the one or more determined intercell interferences; and
means for assigning transmitting power values and corresponding transmitting time durations within the one or more selected cell sites based on the one or more schemes, respectively, to improve total achievable throughput, and therefor capacity, of the entire network.
